(19) United States
(12) Patent Application Publication
(10) Pub. No.: US 2026/0048378 A1
(43) Pub. Date: Feb. 19, 2026

(54) CO2:H2O SELECTIVITY OF ZEOLITES BY WAY OF PTFE COATING

(71) Applicant: Volkswagen Aktiengesellschaft, Wolfsburg (DE)

(72) Inventors: Ali M. Abdel-Mageed, Rostock (DE); Alexander Wotzka, Rostock (DE); Marion Stöhr, Berlin (DE); Sebastian Wohlrab, Ribnitz-Damgarten (DE); Nadine Simon, Wolfsburg (DE); Gerald Block, Lehre (DE); Andreas Grote, Wendeburg (DE); Christine Schütz, Vordorf (OT Rethen) (DE)

(21) Appl. No.: 19/299,133

(22) Filed: Aug. 13, 2025

(30) Foreign Application Priority Data
Aug. 14, 2024 (DE) 102024123191.2

(51) Int. Cl. B01J 20/18; B01D 53/04; B01J 20/28; B01J 20/32

(52) U.S. Cl. CPC B01J 20/18; B01D 53/0438; B01D 53/0462; B01J 20/28085; B01J 20/3272; B01D 2257/504; B01D 2259/40098

(57) ABSTRACT

A method for producing adsorption materials coated with polytetrafluoroethylene (PTFE) includes providing a suspension of PTFE in water (1 to 20 wt % PTFE based on the suspension weight), providing zeolite, mixing the PTFE suspension with the zeolite to form a dispersion, and drying the dispersion to obtain a PTFE-coated adsorption material. The present disclosure also relates to a PTFE-coated adsorption material, its use for adsorbing carbon dioxide from gas mixtures, and a method for extracting carbon dioxide using the PTFE-coated adsorption material. The PTFE coating enhances CO₂:H₂O selectivity, reducing water adsorption while maintaining CO₂ adsorption capacity, enabling efficient carbon dioxide capture, particularly in direct air capture applications.

### RELATED APPLICATIONS

The present application claims priority to German Patent App. No. DE 10 2024 123 191.2, filed Aug. 14, 2024, the contents of which is incorporated by reference in its entirety herein.

### TECHNICAL FIELD

The present disclosure relates to technologies and techniques for producing adsorption materials coated with polytetrafluoroethylene (PTFE), to PTFE-coated adsorption material, to the use of the adsorption material, and to a method for extracting carbon dioxide.

### BACKGROUND

The extraction of carbon dioxide from sources containing carbon dioxide, such as atmospheric air, is increasingly significant. Methods like direct air capture (DAC) can enhance the carbon dioxide balance of various processes and reduce the carbon dioxide content in sources such as waste air or atmospheric air. Effective adsorption materials are essential for these processes, requiring the ability to selectively capture a specific gas, such as carbon dioxide, release it efficiently, and exhibit robust performance over multiple cycles.

Certain adsorption materials, such as zeolites (e.g., 13X zeolite), are known in the art. These materials are recognized for their robustness. However, zeolites like 13X often exhibit insufficient selectivity for carbon dioxide over water vapor (CO₂:H₂O selectivity). This limitation necessitates an energy-intensive pre-drying step for the input air, which increases operational costs. Even with pre-drying, residual water bound in the zeolite requires removal during desorption through an additional energy-intensive process to maintain the material's carbon dioxide adsorption capacity.

To improve the CO₂:H₂O selectivity of zeolite-based adsorption materials, some approaches involve applying coatings, such as those formed through silanization with organic compounds. However, these coatings are often unstable, leading to a progressive reduction in CO₂:H₂O selectivity over multiple adsorption-desorption cycles. In contrast, coatings based on polymers are generally more cost-effective and exhibit greater stability compared to silanized coatings.

Publications such as WO9602322 A1, EP2532421 A1, and EP0659469 A2 describe various zeolite materials suitable for use as adsorption agents, among other applications.

### SUMMARY

Some aspects of the present disclosure provide a method for producing adsorption materials coated with polytetrafluoroethylene (PTFE), an adsorption material coated with PTFE, methods of using the adsorption material, and a method for extracting carbon dioxide, which address one or more of the disadvantages noted in the background.

These aspects are achieved by the claimed technologies and techniques as described in the independent claims, including methods for producing adsorption materials, PTFE-coated adsorption materials, the use of the adsorption material, and methods for extracting carbon dioxide. Additional embodiments of the present disclosure are described in the dependent claims and the following description of exemplary embodiments.

According to some aspects of the present disclosure, a method for producing adsorption materials coated with PTFE includes providing a suspension of PTFE in water, providing zeolite, mixing the PTFE suspension with the zeolite to form a dispersion, and drying the dispersion to obtain a PTFE-coated adsorption material, wherein the PTFE is present in the suspension in a range of 1 to 20 wt % based on the weight of the suspension.

Some aspects of the present disclosure further relate to a method for extracting carbon dioxide, which includes providing a PTFE-coated adsorption material as described herein and contacting a CO2-containing gas mixture with the PTFE-coated adsorption material to adsorb CO2. The gas mixture may include atmospheric air, waste gases, or household emissions, with atmospheric air being preferred. The PTFE-coated adsorption material enables particularly selective CO2 extraction, especially in the presence of water within the gas mixture.

The method for extracting CO2 may further include heating the CO2-adsorbed PTFE-coated adsorption material to release the adsorbed CO2. The heating is conducted at desorption temperatures in the range of 80 to 150° C., preferably 80 to 120° C., and more preferably 80 to 100° C. To optimize energy efficiency, the desorption process balances the duration of desorption with the temperature applied.

### BRIEF DESCRIPTION OF THE DRAWINGS

Exemplary embodiments of the present disclosure are described below with reference to the accompanying drawings, in which:

FIG. 1 is a schematic illustration of a method for producing adsorption materials coated with polytetrafluoroethylene (PTFE), according to some aspects of the present disclosure;

FIG. 2 is a scanning electron microscopy/energy-dispersive X-ray spectroscopy (SEM/EDX) image of 13X zeolite spheres coated with 8.7 wt % PTFE, according to some aspects of the present disclosure;

FIG. 3 is an energy-dispersive X-ray spectroscopy (EDX) analysis of 13X zeolite spheres coated with 8.7 wt % PTFE, according to some aspects of the present disclosure;

FIG. 4 illustrates a thermogravimetric analysis (TGA) and differential scanning calorimetry (DSC) of PTFE-coated zeolite, according to some aspects of the present disclosure;

FIG. 5 presents H2O adsorption BET isotherms comparing unmodified 13X zeolites with PTFE-modified zeolites (2 wt % PTFE), according to some aspects of the present disclosure;

FIG. 6 presents CO2 adsorption BET isotherms comparing unmodified 13X zeolites with PTFE-modified zeolites (2 wt % PTFE), according to some aspects of the present disclosure;

FIG. 7 is a schematic illustration of a method for extracting carbon dioxide, according to some aspects of the present disclosure.

### DETAILED DESCRIPTION

Some embodiments of the present disclosure provide a method for producing adsorption materials coated with polytetrafluoroethylene (PTFE), which includes providing a suspension of PTFE in water, wherein the PTFE is present in the suspension at 1 to 20 wt % based on the total weight of the suspension. The suspension is prepared by mixing a predetermined amount of PTFE with water, preferably distilled water, at a temperature of 10 to 30° C., more preferably 18 to 25° C., and most preferably about 20° C.

The method further includes providing a zeolite as a carrier material for the PTFE coating. The zeolite may be in the form of particles, such as a powder, and is preferably dried prior to use to remove substances such as water, carbon dioxide, or other impurities. Drying may be performed by heating at a temperature of at least 150° C. or by using a combination of vacuum and heating, such as in a vacuum drying oven operating at a temperature of 150° C. to 300° C., preferably 180° C. to 250° C., and more preferably 200° C. to 220° C., with a pressure of 700 to 0.1 mbar, preferably 20 to 0.1 mbar, and more preferably 1 to 0.1 mbar. Lower pressure ranges may increase the energy intensity of the drying process. The drying process may occur over a period of 2 to 20 hours, preferably 5 to 15 hours, and more preferably 8 to 12 hours.

The method further includes mixing the zeolite with the PTFE suspension to form a dispersion, thereby impregnating the zeolite with PTFE. Mixing is performed by stirring the zeolite in the PTFE suspension for a duration of 30 minutes to 5 hours, preferably 1 to 3 hours, and more preferably 2 to 2.5 hours. The zeolite and PTFE suspension are combined at a weight ratio of zeolite to PTFE ranging from 49:1 to 2.33:1, preferably about 4.5:1, based on the total weight of zeolite and PTFE.

The dispersion is then dried to obtain a PTFE-coated adsorption material. Drying may be conducted at room temperature or at elevated temperatures, such as 20° C. to 180° C., preferably 80° C. to 150° C., and more preferably 100° C. to 130° C. In some embodiments, drying employs a temperature gradient with increasing temperatures, such as an initial period at room temperature followed by a period at elevated temperatures. The resulting PTFE-coated zeolite forms primary particles with a size of 2 to 20 micrometers, preferably 4 to 15 micrometers, and more preferably 10 to 15 micrometers.

In certain embodiments, the PTFE in the suspension ranges from 5 to 10 wt %, or more specifically 6 to 9 wt %, and may be 7 wt %, 8 wt %, or 9 wt %, based on the total weight of the suspension.

The zeolite may be selected from the group consisting of 13X zeolite, H-ZSM-5, and 5A, with 13X zeolite being preferred. The zeolite may be in the form of a powder, spheres, grains, or pellets of various shapes (e.g., rectangular or cubic), with a powder form being preferred.

In some embodiments, the method further includes compressing the PTFE-coated adsorption material to form shapes such as granules, spheres, or cylinders, with dimensions ranging from 1 to 5 mm. A spherical shape, such as spheres with a diameter of about 2 mm, is preferred to achieve uniform distribution within bulk material and consistent flow resistance in adsorption applications.

Some aspects of the present disclosure provide a PTFE-coated adsorption material produced by the method described herein. The PTFE content in the adsorption material ranges from 1 to 30 wt %, preferably 15 to 25 wt %, more preferably 7 to 12 wt %, or most preferably 15 to 20 wt %, based on the total weight of the adsorption material. The PTFE content is controlled by adjusting the PTFE concentration in the suspension during the production method. The zeolite in the PTFE-coated adsorption material may have a diameter of 2 to 8 mm, preferably 3 to 6 mm, and more preferably 3 to 4 mm.

The PTFE coating enhances the CO2:H2O selectivity of the adsorption material while reducing water adsorption, thereby lowering the energy required for desorption and reducing the need for pre-drying the input gas. The adsorption material exhibits robust performance, with water adsorption capacity reduced by approximately 4 to 6 times in a pressure range of 0.05 to 0.02 kPa, while the CO2 adsorption capacity remains substantially unchanged in the same pressure range, resulting in a relative increase in CO2:H2O selectivity by 4 to 6 times.

Some aspects of the present disclosure relate to the use of the PTFE-coated adsorption material for adsorbing carbon dioxide from a gas mixture, such as atmospheric air, waste gas, or household emissions, with atmospheric air being preferred. The PTFE-coated adsorption material may be used in a direct air capture (DAC) method, where it limits water adsorption in the relevant working pressure range without significantly impairing CO2 adsorption, thereby improving selectivity for CO2 in the presence of moisture, which is critical for DAC technologies aimed at reducing CO2 emissions. The PTFE-coated adsorption material may also be used to adsorb CO2 in applications within the chemical industry, petroleum industry, or by CO2 emitters such as aluminum works, cement factories, or power plants.

FIG. 1 is a schematic illustration of a method for producing adsorption materials coated with polytetrafluoroethylene (PTFE), which includes providing a suspension of PTFE in water (1 to 20 wt % PTFE based on the total weight of the suspension), providing zeolite, mixing the PTFE suspension with the zeolite to form a dispersion, and drying the dispersion to obtain a PTFE-coated adsorption material, according to some aspects of the present disclosure.

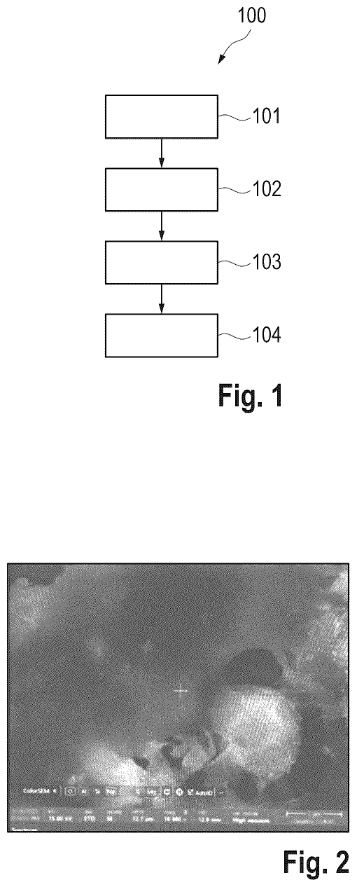

FIG. 2 is a scanning electron microscopy/energy-dispersive X-ray spectroscopy (SEM/EDX) image of 13X zeolite spheres coated with 8.7 wt % PTFE. The extent of PTFE coverage on the zeolite particles depends on the PTFE loading selected during the production process, as confirmed by SEM and EDX measurements, according to some aspects of the present disclosure.

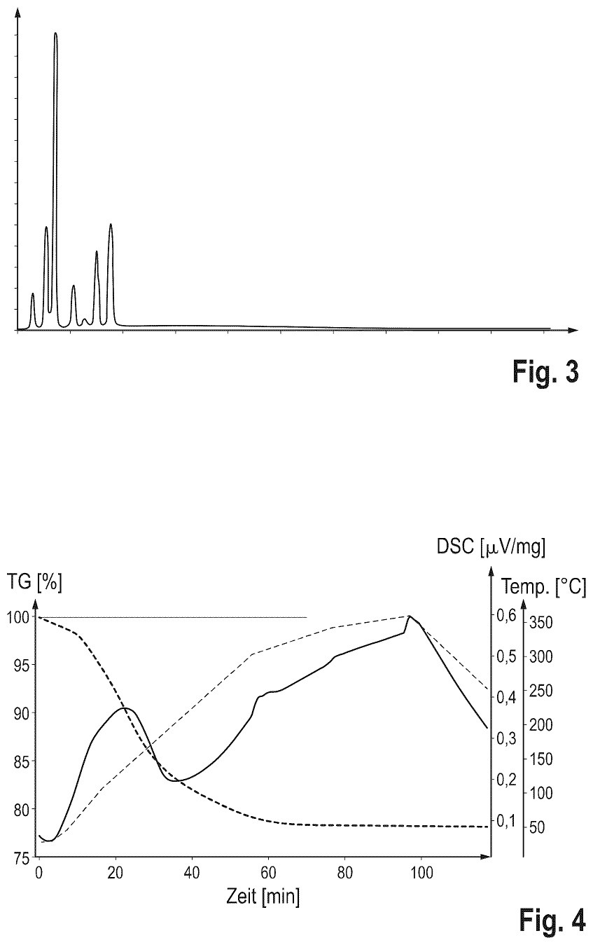

FIG. 3 is an energy-dispersive X-ray spectroscopy (EDX) analysis of 13X zeolite spheres coated with 8.7 wt % PTFE, according to some aspects of the present disclosure.

FIG. 4 illustrates a thermogravimetric analysis (TGA, thick dotted line) and differential scanning calorimetry (DSC, solid line) of PTFE-coated zeolite in a temperature range of 25 to 350° C. The left Y-axis indicates the sample's mass loss, the right Y-axis represents the DSC results or temperature scale, and the thin dotted line shows the temperature profile. The analysis demonstrates thermal stability, with mass loss in the low-temperature range attributed to water desorption and no mass loss observed up to 350° C., indicating no decomposition of the PTFE coating, according to some aspects of the present disclosure.

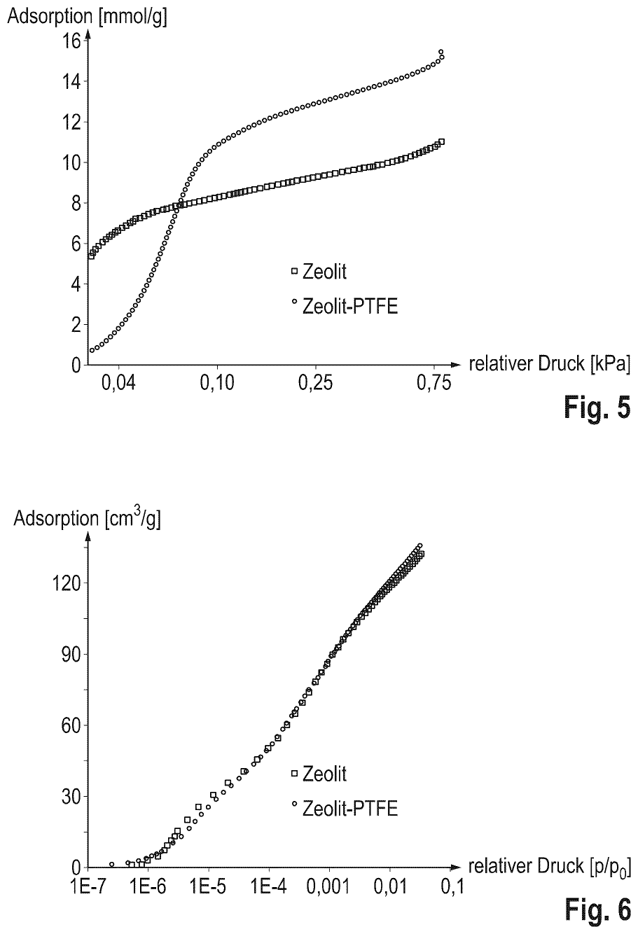

FIG. 5 presents H2O adsorption BET isotherms comparing unmodified 13X zeolites with PTFE-modified zeolites (2 wt % PTFE), according to some aspects of the present disclosure.

FIG. 6 presents CO2 adsorption BET isotherms comparing unmodified 13X zeolites with PTFE-modified zeolites (2 wt % PTFE). The PTFE modification significantly reduces H2O adsorption at low pressures (approximately 0.06 kPa) while maintaining CO2 adsorption capacity in the same pressure range, resulting in enhanced CO2:H2O selectivity in the presence of water, according to some aspects of the present disclosure.

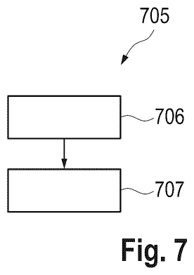

FIG. 7 is a schematic illustration of a method for extracting carbon dioxide, which includes providing a PTFE-coated adsorption material and contacting a CO2-containing gas mixture with the PTFE-coated adsorption material to adsorb CO2, according to some aspects of the present disclosure.

An exemplary embodiment of producing and using PTFE-coated zeolites as a sorbent for capturing CO2 from atmospheric air involves hydrophobation of 13X zeolite with PTFE, performed as follows: First, a suspension of PTFE in water (5 wt % PTFE) is prepared by combining 2 g of 2% PTFE solution with 2 g of water. Next, 1 g of zeolite powder or spheres is dried in a vacuum drying oven at 200° C. for at least 12 hours to remove adsorbed water or carbon dioxide. The zeolite is then impregnated with the PTFE suspension by stirring the mixture at room temperature for 2 hours, during which the mixture may heat up and exhibit brief foaming initially. The modified zeolite is filtered and dried, first at room temperature and then at 130° C. for 8 hours in a drying oven. The extent of PTFE coverage on the zeolite particles depends on the selected PTFE loading, as confirmed by SEM and EDX measurements (see FIG. 2 and FIG. 3), according to some aspects of the present disclosure.

### LIST OF REFERENCE NUMERALS

100 method for producing adsorption materials coated with polytetrafluoroethylene (PTFE)
101 providing a suspension of PTFE in water
102 providing zeolite
103 mixing the suspension of PTFE with the zeolite to form a dispersion
104 drying the dispersion
705 method for extracting CO₂
706 providing an adsorption material coated with polytetrafluoroethylene (PTFE)
707 bringing a CO₂-containing gas mixture in contact with the adsorption material coated with polytetrafluoroethylene (PTFE)

1. A method for producing a polytetrafluoroethylene (PTFE)-coated adsorption material, the method comprising:
providing a suspension of PTFE in water, wherein the PTFE is present in an amount of 1 to 20 wt % based on a total weight of the suspension;
providing a zeolite;
mixing the suspension with the zeolite to form a dispersion; and
drying the dispersion to obtain the PTFE-coated adsorption material.

2. The method of claim 1, wherein the PTFE is present in an amount of 5 to 10 wt % based on the total weight of the suspension.

3. The method of claim 1, wherein the zeolite is selected from the group consisting of 13X zeolite, H-ZSM-5, and 5A zeolite.

4. The method of claim 1, wherein the zeolite is in a form selected from the group consisting of a powder, spheres, grains, and pellets.

5. The method of claim 1, wherein the drying is performed at a temperature in a range of 20° C. to 180° C.

6. The method of claim 1, further comprising compressing the PTFE-coated adsorption material.

7. The method of claim 1, wherein the mixing is performed at a weight ratio of zeolite to PTFE in a range of 49:1 to 2.33:1 based on a total weight of the zeolite and PTFE.

8. A polytetrafluoroethylene (PTFE)-coated adsorption material comprising a zeolite coated with PTFE, wherein the PTFE is present in an amount of 1 to 20 wt % based on a total weight of the adsorption material, and wherein the adsorption material exhibits a CO₂:H₂O selectivity increased by 4 to 6 times compared to an uncoated zeolite in a pressure range of 0.02 to 0.05 kPa.

9. The PTFE-coated adsorption material of claim 8, wherein the PTFE is present in an amount of 7 to 12 wt % based on the total weight of the adsorption material.

10. The PTFE-coated adsorption material of claim 8, wherein the zeolite has a diameter in a range of 2 to 8 mm.

11. The PTFE-coated adsorption material of claim 8, wherein the zeolite is selected from the group consisting of 13X zeolite, H-ZSM-5, and 5A zeolite.

12. The PTFE-coated adsorption material of claim 8, wherein the zeolite is in a form selected from the group consisting of a powder, spheres, grains, and pellets.

13. The PTFE-coated adsorption material of claim 8, wherein the adsorption material is configured to adsorb carbon dioxide from a gas mixture comprising atmospheric air in a direct air capture method.

14. The PTFE-coated adsorption material of claim 8, wherein the adsorption material is configured to adsorb carbon dioxide from a gas mixture, and wherein the adsorption material with adsorbed CO2 is heated at a temperature in a range of 80° C. to 150° C. to release the CO2.

15. A method for extracting carbon dioxide, comprising:
providing a polytetrafluoroethylene (PTFE)-coated adsorption material comprising a zeolite coated with PTFE, wherein the PTFE is present in an amount of 1 to 20 wt % based on a total weight of the adsorption material, and wherein the adsorption material exhibits a CO₂:H₂O selectivity increased by 4 to 6 times compared to an uncoated zeolite in a pressure range of 0.02 to 0.05 kPa; and
contacting a CO₂-containing gas mixture with the PTFE-coated adsorption material to adsorb CO₂ onto the adsorption material.

16. The method of claim 15, further comprising heating the PTFE-coated adsorption material having adsorbed CO₂ to release the CO₂.

17. The method of claim 15, wherein the CO₂-containing gas mixture comprises atmospheric air, waste gases, or household emissions.

18. The method of claim 15, wherein the CO₂-containing gas mixture comprises atmospheric air, and the method is a direct air capture method.

19. The method of claim 15, wherein the zeolite is selected from the group consisting of 13X zeolite, H-ZSM-5, and 5A zeolite.

20. The method of claim 16, wherein the heating is performed at a temperature in a range of 80° C. to 150° C.
